(19) United States
(12) Patent Application Publication
(10) Pub. No.: US 2026/0043753 A1
(43) Pub. Date: Feb. 12, 2026

(54) Double Beam ThemoReflectance Spectroscopy (DBTRS) for Conductive Area Inspection

(71) Applicants: Taiwan Semiconductor Manufacturing Company, LTD., Hsinchu (TW); TSMC ARIZONA CORPORATION, Phoenix, AZ (US)

(72) Inventors: Wen-Hsien Chuang, Taipei (TW); Chia-Hsiang Chen, Hsinchu (TW); Ji-Feng Ying, Hsinchu (TW); Xuewen Tang, Gilbert, AZ (US)

(21) Appl. No.: 18/971,507

(22) Filed: Dec. 6, 2024

Related U.S. Application Data
(60) Provisional application No. 63/679,839, filed on Aug. 6, 2024.

(51) Int. Cl. G01N 21/956; G01N 21/17; G01N 21/88

(52) U.S. Cl. CPC G01N 21/95684; G01N 21/1717; G01N 21/8806; G01N 2021/1731; G01N 2021/8845

(57) ABSTRACT

A method and system of detecting a conductive path state of a conductive target test area interconnect structure on a semiconductor wafer substrate, the method including directing a pump laser and probe laser incident on an exposed surface of a conductive target test area, the pump laser heating the conductive target test area which is interconnected to an underlying interconnect structure of a semiconductor wafer substrate. Measuring the intensity of the probe laser reflected by the exposed surface of the conductive target test area, and using the measured intensity of the reflected probe laser to determine a conductive path state of the conductive target test area and the underlying interconnect structure.

### PRIORITY CLAIM AND CROSS-REFERENCE

This application claims the benefit of U.S. Provisional Application Ser. No. 63/679,839, filed Aug. 6, 2024, and titled DOUBLE BEAM THEMOREFLECTANCE SPECTROSCOPY (DBTRS) FOR METAL VIA INSPECTION, which is incorporated herein by reference its entirety.

### BACKGROUND

The invention relates to the fabrication of integrated circuit devices, and more particularly, to a method for the identification of defects or imperfections in components or component elements during the creation of semiconductor devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a Double Beam Thermoreflectance Spectroscopy (DBTRS) system for conductivity inspection of a target test area according to an example embodiment of the present disclosure (Embodiment 1A), the DBTRS system including a pump laser incident on a metal via and a probe laser incident and reflected from the metal via after heating by the pump laser.

FIG. 1B is a time vs intensity graph of the input pump laser beam and input probe laser beam (Embodiment 1A) according to an example embodiment of the present disclosure.

FIG. 1C is a time vs intensity graph of the output or reflected probe laser beam (Embodiment 1A) according to an example embodiment of the present disclosure.

FIG. 1D is a further detailed view of a DBTRS system for conductivity inspection of a target test area (Embodiment 1A) according to an example embodiment of the present disclosure, the detailed view depicting the pump laser incident angle relative to the conductive test area, i.e. metal via, and depicting the probe laser incident and reflected angles relative to the conductive test area, i.e. metal via.

FIG. 1E is another further detailed view of a DBTRS system for conductivity inspection of a target test area (Embodiment 1A) according to an example embodiment of the present disclosure, the detailed view depicting the spacing or separation of the pump laser beam incident on the conductive test area and the probe laser incident on the conductive test area.

FIG. 1F illustrates a DBTRS system for conductivity inspection of a target test area (Embodiment 1B) according to an example embodiment of the present disclosure, where the pump laser beam and probe laser beam are parallel and perpendicular to the DUT (Device Under Test) conductive test area.

FIG. 1G illustrates a DBTRS system for conductivity inspection of a target test area (Embodiment 1C) according to an example embodiment of the present disclosure, where the pump laser beam is obliquely aligned to the DUT conductive test area, and the probe laser beam is perpendicular to the DUT conductive test area.

FIG. 1H illustrates a DBTRS system for conductivity inspection of a target test area (Embodiment 1D) according to an example embodiment of the present disclosure, where the pump laser beam is perpendicular to the DUT conductive test area, and the probe laser beam is obliquely aligned to the DUT conductive test area.

FIG. 1I illustrates a DBTRS system for conductivity inspection of a target test area (Embodiment 1E) according to an example embodiment of the present disclosure, where the pump laser beam and probe laser beam are obliquely aligned to the DUT conductive test area.

FIG. 2A illustrates another DBTRS system for conductivity inspection of a target test area (Embodiment 2) according to an example embodiment of the present disclosure, the DBTRS system including a wafer scanning configuration to perform a continuous scan of a wafer to generate a wafer map visually indicating the conductive path states of a plurality of conductive target test areas and associated interconnect structures on the wafer.

FIG. 2B illustrates the wafer and wafer holder rotational direction associated with the DBTRS system shown in FIG. 2A (Embodiment 2) according to an example embodiment of the present disclosure.

FIG. 2C illustrates a wafer and wafer holder rotational scan path associated with the DBTRS system shown in FIG. 2A (Embodiment 2) according to an example embodiment of the present disclosure.

FIG. 2D illustrates a wafer and wafer holder y directional scan path associated with the DBTRS system shown in FIG. 2A (Embodiment 2) according to an example embodiment of the present disclosure.

FIG. 2E illustrates a wafer and wafer holder x directional scan path associated with the DBTRS system shown in FIG. 2A (Embodiment 2) according to an example embodiment of the present disclosure.

FIG. 3 illustrates another DBTRS system for conductivity inspection of a target test area according to an example embodiment (Embodiment 3) of the present disclosure, the DBTRS system including a pump laser beam and probe laser beam incident on a dielectric area of a dielectric layer(s), the dielectric area adjacent to metal vias formed thru the dielectric layer(s).

FIGS. 4A, 4B and 4C illustrate a plurality of conductive path states determined by the disclosed DBTRS system, the plurality of conductive path states including State 1: Direct/Nonresistant conductive path (FIG. 4A), State 2: Open conductive path (FIG. 4B) and State 3: Resistant conductive path (FIG. 4C), according to an example embodiment of the present disclosure.

FIG. 4D is a cross sectional view of an example semiconductor structure (Embodiment 4) including a metal via and underlying interconnect structure that is tested for continuity using a DBTRS according to an example embodiment of the present disclosure.

FIG. 4E is a detailed cross sectional view of the metal via shown in FIG. 4D (Embodiment 4) according to an example embodiment of the present disclosure.

FIG. 4F is a top of an example semiconductor structure (Embodiment 4) including a plurality of metal vias and underlying interconnect structures, as shown in FIG. 4D, that is tested for continuity using a DBTRS according to an example embodiment of the present disclosure.

FIG. 5A is a cross sectional view of an example semiconductor structure (Embodiment 5A) including a metal interconnect and via, and underlying interconnect structure that is tested for continuity using a DBTRS according to an example embodiment of the present disclosure.

FIG. 5B is a detailed cross sectional view of the metal interconnect and via, shown in FIG. 5A (Embodiment 5A) according to an example embodiment of the present disclosure.

FIG. 5C is a top of an example semiconductor structure (Embodiment 5B) including a plurality of metal interconnects and vias, and underlying interconnect structures (not shown) as shown in FIG. 5A, that is tested for continuity using a DBTRS according to an example embodiment of the present disclosure.

FIG. 5D is a top of another example semiconductor structure (Embodiment 5C) including a plurality of metal interconnects and vias, and underlying interconnect structures (not shown), as shown in FIG. 5A, that is tested for continuity using a DBTRS according to an example embodiment of the present disclosure.

FIG. 6 is a cross sectional view of an example double sided metal interconnect semiconductor structure (Embodiment 6) including a frontside metal interconnect structure, a Si substrate including a MOS transistor device and a backside metal interconnect structure, the frontside and backside metal interconnect structures tested for continuity using a DBTRS according to an example embodiment of the present disclosure.

FIG. 7 is a flow chart of a method of detecting a conductive path state of a conductive target test area interconnect structure on a semiconductor wafer substrate according to an example embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g., “about 2 to about 4” also discloses the range “from 2 to 4.” The term “about”may refer to plus or minus 10% of the indicated number.

The present disclosure relates to structures which are made up of different layers. When the terms “on” or “upon” are used with reference to two different layers (including the substrate), they indicate merely that one layer is on or upon the other layer. These terms do not require the two layers to directly contact each other, and permit other layers to be between the two layers. For example, all layers of the structure can be considered to be “on” the substrate, even though they do not all directly contact the substrate. The term “directly” may be used to indicate two layers directly contact each other without any layers in between them. In addition, when referring to performing process steps to the substrate, this should be construed as performing such steps to whatever layers may be present on the substrate as well, depending on the context.

The term “laser” or “laser beam,” as used herein, may include a laser beam including one or more laser beams.

The term “radiation source,” as used herein, may include a laser source, light-emitting diode (LED) source, infrared source, optical spectrum radiant sources including but not limited to the visible spectrum, ultraviolet (UV) spectrum and infrared (IR) spectrum, and other heating type radiant sources including but not limited to electromagnetic wave emission sources.

The term “Device Under Test” and “DUT,” as used herein, may include any semiconductor type device or other type device that includes an exposed surface of a conductive feature that is electrically or conductively interconnected to an underlying interconnect structure.

The term “conductive feature,” as used herein, may include a metallization layer contact, patterned metallization layer contact, metal via or other electrical metal contact.

The term “conductive target test area,” as used herein, may include a metal via, metal interconnect, metallization layer contact, patterned metallization layer contact, other electrically conductive contact or surface, or other metal wire type connection point and contact.

The term “intermetal dielectric” (IMD) film or layer, as used herein, refers to a dielectric/insulation material(s) layer between two metal layers.

The term “interlayer dielectric” (ILD) layer, as used herein, refers to an insulating structure of material(s) placed between two conductive layers.

Various approaches exist for wafer-level testing of IC devices, that is, prior to dicing the wafer to separate individual IC dies. Wafer acceptance test (WAT) approaches electrically probe circuitry. However, WAT is performed after back-end-of-line (BEOL) processing is (at least mostly) complete, and is tedious and time consuming. Electron beam microscopy of the wafer using a scanning electron microscope (SEM) can be performed after the front end-of-line (FEOL) processing and before BEOL processing, thus providing detection of defects earlier in the fabrication process. Additionally, analysis of the acquired SEM images to detect defects can be automated using various techniques such as matched filtering, comparison against a reference image (e.g., computing a difference image between the acquired SEM image and the reference image such that defects in the former show up as distinct regions of difference), or a machine learning (ML) tool such as a trained artificial neural network (ANN). However, SEM imaging provides structural information but not electrical information, and furthermore it may be challenging to detect small defects in the SEM image. Conversely, SEM imaging may detect structural defects that are not electrical defects.

Charge induced voltage contrast (VC) electron beam inspection (EBI) is another technique which is also performed using an SEM. In VC EBI, secondary electron (SE) yield is measured so as to provide voltage contrast. This enables direct observation of certain electrical defects. VC EBI can be performed after middle end-of-line (MEOL) processing in which contacts have been formed (also sometimes referred to in the art as MD metallization), thus also providing early detection of defects. As with structural SEM imaging, analysis of VC EBI images to detect defects can advantageously be automated using matched filtering, comparison with a reference image, trained ANN or other trained ML tool, or so forth.

However, while VC EBI can detect shorting and open circuit conditions/states between contact features, other types of electrical defects are typically not detectable by this technique, such as partially open/shorted conductive paths, i.e., resistant conductive paths, which indicate an undesirable partial short or open condition. Furthermore, existing VC techniques are relatively expensive and slow, requiring a vacuum system are only useful for local inspections, not for wafer mapping which requires great amount of time to complete using a VC system.

The following discloses improvements to semiconductor wafer and die quality inspection techniques for inspecting electrically conductive properties of electrical interconnect structures and their underlying interconnect structure, such as metal via, metal interconnects, etc. Specifically, an optical method and system is used to detect electrical conductivity defects which enables a relatively higher throughput of the quality inspection process, relative to the VC techniques currently employed, as well as providing the ability to perform continuous scanning and mapping of a wafer to determine the quality of the wafer conductive features.

According to an example embodiment, the disclosed methods and systems uses one (pump) laser to heat up a target test area, such as a metal via, metal interconnect or dielectric region adjacent to a conductive area to be tested, and another (probe) laser to detect the reflectance change of the target test area through transient measurements. Different thermal conductivities of the target test area each represent different electrically conductive states of the target test area conductivity to the underlying interconnect structure(open, resistive, or short). The different thermal properties of the target test area, i.e., temperature, provide different reflectance properties of the probe laser, where the reflectance of the target test area is inversely proportional to the temperature of the target test area. Offsetting of pump and probe laser spots incident on the target test area, a probe emission delay relative to the pump laser emission, and a moving wafer stage provide continuous scanning and mapping of the wafer during testing.

As briefly stated above, the present disclosure relates to a metal via, metal interconnect and/or conductive contact conductivity detection and measurement tool for the quality inspection of semiconductor wafers, dies, and device structures. More generally, this disclosure provides a Double Beam Thermoreflectance Spectroscopy (DBTRS) method and system for conductivity inspection of a target test area. According to an example embodiment described herein, the disclosed method and system use an optical detection and measurement system to inspect exposed metal via and/or metal interconnect electrical conductivity to an underlying interconnect structure, such as frontside and backside metal vias and metal interconnects, at a wafer level. However, the disclosed methods and systems can also be used to perform electrical conductivity inspections at a die level, as well as at intermediate stages of a semiconductor devices fabrication.

More specifically, this disclosure provides methods and system for testing the conductivity of conductive features, such as metal vias, metal interconnects, etc. in a semiconductor interconnect structure. The testing system disclosed is an optical testing system including a first laser source, such as a pump laser, a second laser source, such as a probe laser, and an optical detector that measures the reflectivity of the second laser source/probe laser beam reflected from a targeted electrically conductive test area that is exposed/heated by the pump laser beam. The optical detector measured reflectivity of the target test area, (metal via exposed surface, metal interconnect exposed surface, etc.) is dependent on the temperature of the heated target test area, and the temperature of the target test area is dependent on the thermal conductivity of the tested conductive feature i.e. metal via, metal interconnect, etc. to the underlying interconnect structure, where the reflectivity of the exposed surface is inversely proportional to the temperature of the conductive target test area, i.e. a higher temperature induces a lower reflectance. In other words, a cooler temperature of the target test area indicates the metal via, metal interconnect, etc. is “correctly” connected to the underlying interconnect structure and includes a direct/nonresistant conductive path as desired. Conversely, a warmer temperature of the target test area relative to a normal or direct/nonresistant conductive path reference or threshold temperature of the target test area indicates an undesired resistance in the thermal conduction path from the heated exposed test area surface to the underlying interconnect structure, thereby indicating an open conductive path or a partially open/shorted conductive path, from the target test area to the underlying interconnect structure.

According to an example embodiment, the DBTRS includes: (1) pump laser (to be absorbed by the target conductive area), (2) probe laser (to be reflected by the heated target conductive area) (3) DUT (4) Detector (photo detection), and (5) wafer stage with wafer motion control. An example basic set up includes the two laser source with an offset between pump and probe laser spots (e.g. 10 nm˜1 mm), the pump laser emission/spot wavelength<700 nm with a pulse width of about 1 fs to about 1 s. In the case where the target conductive material is Cu, a relatively better and advantageous absorption efficiency is achieved using a laser with a wavelength range <700 nm. If an extended penetration range is desired, a pump laser wavelength within or about the IR range of about 1000 nm to 3000 nm will provide a deeper penetration depth of the pump laser within the target conductive area. Other conductive target area heat sources are within the scope of this disclosure, and may include any electromagnetic radiation source capable of heating the conductive target area.

The probe laser wavelength is about or less than 5000 nm with a pulse width of about 1 fs to about 1 s. The advantage and benefit of using a relatively higher wavelength range for the probe laser, as compared to the pump laser, relates to the reflective characteristics of the conductive target area material which are dependent, in part, on the probe laser wavelength. The probe laser source, according to other embodiments, could be other light sources, including but not limited to an LED. However, the incident light needs to be locally focused to the conductive target area with a small range of wavelength span where most of the collected light is reflected to the detector.

According to this example embodiment, some advantages and benefits of having pump and probe laser spots incident and offset 10 nm to 1 mm on the target test area, includes the precise control of a representative region or area of the conductive target test area to tested, and avoiding unwanted interference or signal contamination of the reflected probe laser.

Another possible embodiment of the DBTRS includes a single laser source configured to emit the pump laser and the probe laser with different wavelengths, or operate as a single wavelength laser source to provide the pump laser and the probe laser, however less efficiency of throughput testing/scanning of a DUT and optimization of the laser source is expected.

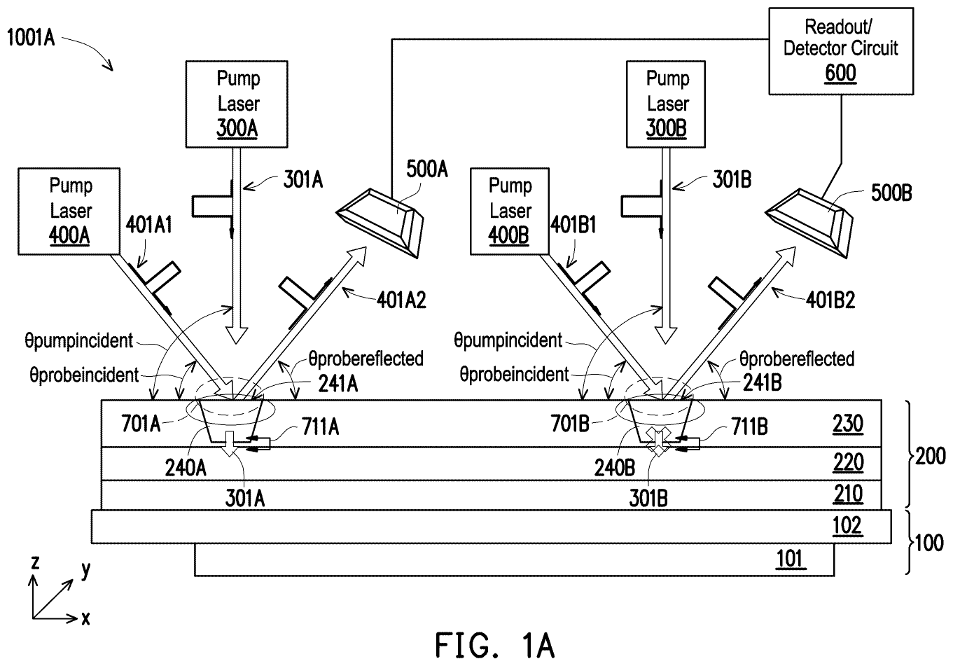

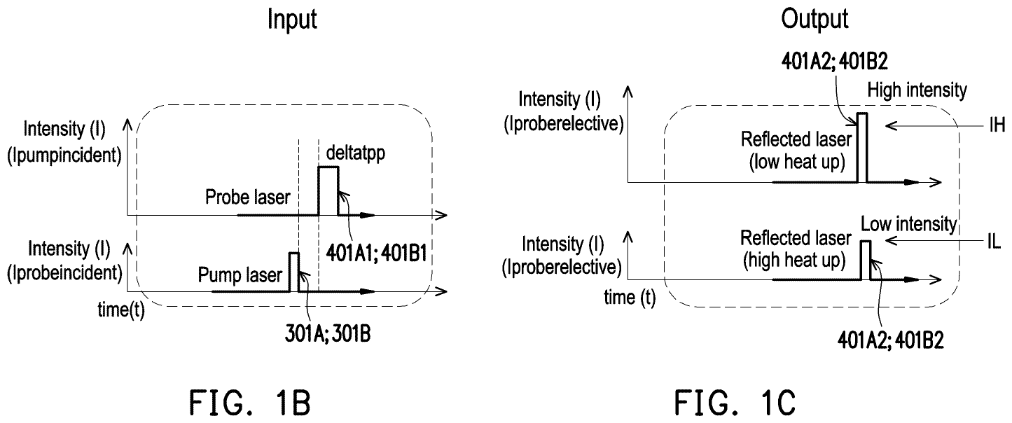

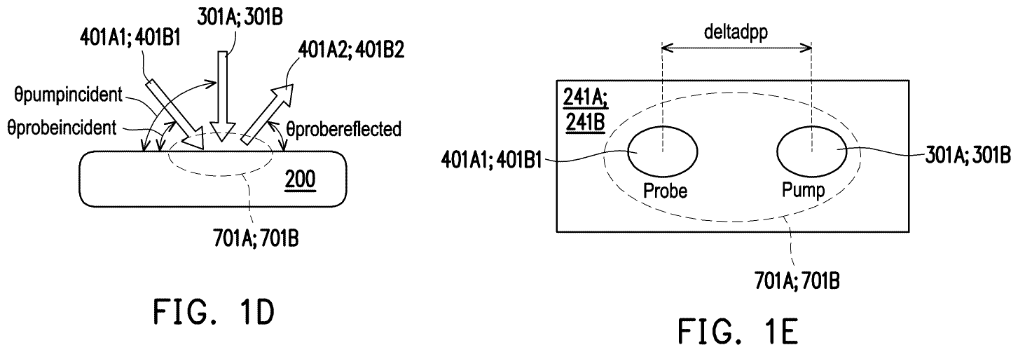

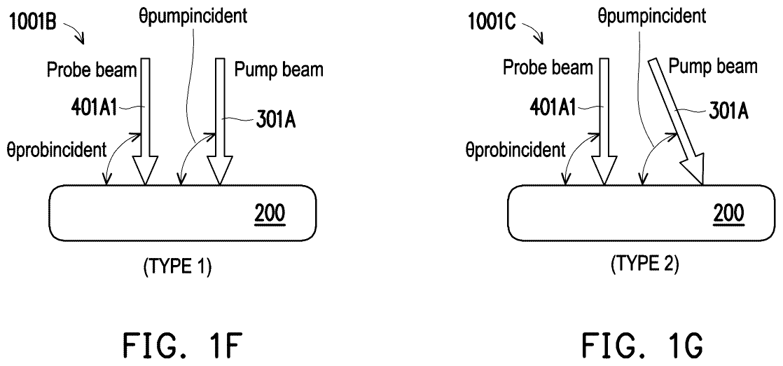

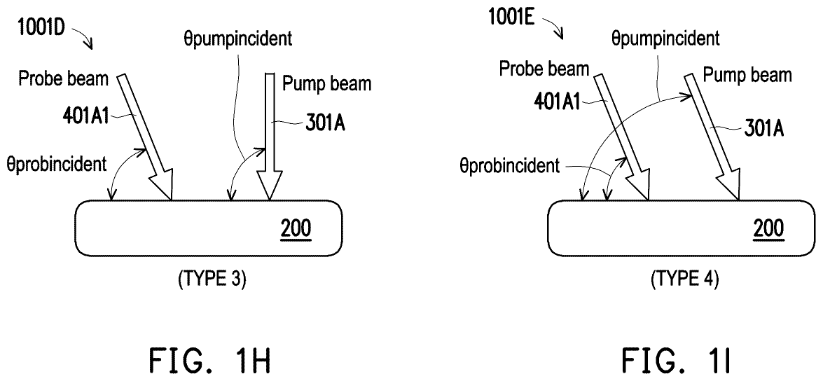

With reference to FIG. 1A, illustrated is a Double Beam Thermoreflectance Spectroscopy (DBTRS) system 1001A for conductivity inspection of a target test area according to an example embodiment of the present disclosure (Embodiment 1A), the DBTRS system 1001A including pump lasers 300A and 300B incident on metal vias 240A and 240B, respectively, and a probe lasers 400A and 400B incident and reflected from the metal vias 240A and 240B, respectively, after heating by the pump laser.

As shown, the DBTRS system is used for the inspection of a semiconductor structure including a substrate 210, a metal mesh structure 220 formed on the substrate 210, a dielectric interconnect structure formed on the metal mesh structure 220, and metal vias 240A and 240B which extend through the dielectric layer 230 and provide an electrically conductive path to the metal mesh structure 220. The metal vias 240A and 240B have exposed electrical contact surfaces 241A and 241B, respectively, which provide for external electrical connections of the semiconductor structure, i.e., DUT, to another device, wafer or die.

According to an example embodiment, the DUT 200 is a wafer made of a semiconducting material, where the integrated interconnect structure 200 or integrated circuit (IC) is built or formed thereon by conventional semiconductor fabrication techniques, including but not limited to photolithographic techniques such as applying a pattern/structure in a given layer by applying a photoresist layer, patterning the photoresist layer, developing the photoresist layer, and then etching, followed by planarizing and cleaning. While the semiconductor fabrication processes required to form the DUT 200 shown are not the focus of this disclosure, for completeness a general description of the semiconductor fabrication processes follows.

The semiconductor substrate 210 materials can include silicon, for example in the form of crystalline Si or polycrystalline Si. In alternative embodiments, the substrate can be made of other elementary semiconductors such as germanium, or may include a compound semiconductor such as silicon carbide (SiC), gallium arsenide (GaAs), gallium carbide, gallium phosphide, indium arsenide (InAs), indium phosphide (InP), silicon germanium, silicon germanium carbide, gallium arsenic phosphide, or gallium indium phosphide. In particular embodiments, the wafer substrate is silicon.

Generally, a photoresist layer may be applied, for example, by spin coating, or by spraying, roller coating, dip coating, or extrusion coating. Typically, in spin coating, the substrate is placed on a rotating platen, which may include a vacuum chuck that holds the substrate in plate. The photoresist composition is then applied to the center of the substrate. The speed of the rotating platen is then increased to spread the resist evenly from the center of the substrate to the perimeter of the substrate. The rotating speed of the platen is then fixed, which can control the thickness of the final photoresist layer.

Next, the photoresist composition is baked or cured to remove the solvent and harden the photoresist layer. In some particular embodiments, the baking occurs at a temperature of about 90° C. to about 110° C. The baking can be performed using a hot plate or oven, or similar equipment. As a result, the photoresist layer is formed on the substrate.

The photoresist layer is then patterned via exposure to radiation. The radiation may be any light wavelength which carries a desired mask pattern. In particular embodiments, EUV light having a wavelength of about 13.5 nm is used for patterning, as this permits smaller feature sizes to be obtained. This results in some portions of the photoresist layer being exposed to radiation, and some portions of the photoresist not being exposed to radiation. This exposure causes some portions of the photoresist to become soluble in the developer and other portions of the photoresist to remain insoluble in the developer.

An additional photoresist bake step (post exposure bake, or PEB) may occur after the exposure to radiation. For example, this may help in releasing acid leaving groups (ALGs) or other molecules that are significant in chemical amplification photoresist.

The photoresist layer is then developed using a developer. The developer may be an aqueous solution or an organic solution. The soluble portions of the photoresist layer are dissolved and washed away during the development step, leaving behind a photoresist pattern. One example of a common developer is aqueous tetramethylammonium hydroxide (TMAH). Other developers may include 2-heptanone, n-butyl acetate, isoamyl acetate, cyclohexanone, 5-methyl-2-hexanone, methyl-2-hydroxyisobutyrate, ethyl lactate or propylene glycol monomethyl ether acetate, n-pentyl acetate, n-butyl propionate, n-hexyl acetate, n-butyl butyrate, isobutyl butyrate, 2,5-dimethyl-4-hexanone, 2,6-dimethyl-4-heptanone, propyl isobutyrate, or isobutyl propionate. Generally, any suitable developer may be used. Sometimes, a post develop bake or “hard bake” may be performed to stabilize the photoresist pattern after development, for optimum performance in subsequent steps.

Continuing, portions of the layer below the patterned photoresist layer are now exposed. Etching transfers the photoresist pattern to the layer below the patterned photoresist layer. After use, the patterned photoresist layer can be removed, for example, using various solvents such as N-methyl-pyrrolidone (NMP) or alkaline media or other strippers at elevated temperatures, or by dry etching using oxygen plasma.

Generally, any etching step used herein may be performed using wet etching, dry etching, or plasma etching processes such as reactive ion etching (RIE) or inductively coupled plasma (ICP), or combinations thereof, as appropriate. The etching may be anisotropic. Depending on the material, etchants may include carbon tetrafluoride (CF₄), hexafluoroethane (C₂F₆), octafluoropropane (C₃F₈), fluoroform (CHF₃), difluoromethane (CH₂F₂), fluoromethane (CH₃F), trifluoromethane (CHF₃), carbon fluorides, nitrogen (N₂), hydrogen (H₂), oxygen (O₂), argon (Ar), xenon (Xe), xenon difluoride (XeF₂), helium (He), carbon monoxide (CO), carbon dioxide (CO₂), fluorine (F₂), chlorine (Cl₂), oxygen (O₂), hydrogen bromide (HBr), hydrofluoric acid (HF), nitrogen trifluoride (NF₃), sulfur hexafluoride (SF₆), boron trichloride (BCl₃), ammonia (NH₃), bromine (Br₂), nitrogen trifluoride (NF₃), or the like, or combinations thereof in various ratios. For example, silicon dioxide can be wet etched using hydrofluoric acid and ammonium fluoride. Alternatively, silicon dioxide can be dry etched using various mixtures of CHF₃, O₂, CF₄, and/or H₂.

Planarizing may be performed to obtain a flat surface. The planarizing may be performed, for example, using a chemical mechanical polishing (CMP) process. Generally, CMP is performed using a rotating platen to which a polishing pad is attached. The substrate is attached to a rotating carrier. A slurry or solution containing various chemicals and abrasives is dispensed onto the polishing pad or the wafer substrate. During polishing, both the polishing pad and the carrier rotate, and this induces mechanical and chemical effects on the surface of the wafer substrate and/or the top layer thereon, removing undesired materials and creating a highly level surface. A post-CMP cleaning step is then carried out using rotating scrubber brushes along with a washing fluid to clean one or both sides of the wafer substrate.

Finally, cleaning steps such as wet cleaning may be performed between various processing steps. The cleaning solution will depend on the etch recipe and the exposed layers. Examples of cleaning solutions may include deionized water, dilute HF, and other conventional solutions.

Dielectric structures 230 can be made from any suitable combination of dielectric materials. Examples of dielectric materials may include silicon dioxide (SiO₂), silicon nitride (Si₃N₄), silicon carbide (SiC), hafnium dioxide (HfO₂), zirconium dioxide (ZrO₂), aluminum oxide (Al₂O₃), silicon oxynitride (SiOₓN_{y}), hafnium oxynitride (HfOₓN_{y}) or zirconium oxynitride (ZrOₓN_{y}), or hafnium silicates (ZrSiₓO_{y}) or zirconium silicates (ZrSiₓO_{y}) or silicon carboxynitride (SiCₓO_{y}N_{z}), or hexagonal boron nitride (hBN). Other dielectric materials may include tantalum oxide (Ta₂O₅), nitrides such as silicon nitride, polysilicon, phosphosilicate glass (PSG), fluorosilicate glass (FSG), undoped silicate glass (USG), high-stress undoped silicate glass (HSUSG), and borosilicate glass (BSG).

Any electrically conductive material, such as metal vias 240A and 240B, discussed herein may generally be any conductive metal or conductive oxide. Examples of suitable metals may include copper, aluminum, nickel, chromium, gold, germanium, silver, titanium, tungsten, platinum, tantalum, ruthenium, cobalt, rhenium, palladium, or zirconium; composites like TiN, WN, or TaN; or alloys thereof like AlCu. Examples of suitable conductive oxides may include indium tin oxide (ITO), zinc oxide (ZnO), tin oxide (SnO), aluminum zinc oxide (AlZnO), indium oxide (InO), or cadmium oxide (CdO). The metal or oxide material may be deposited, for example, via evaporation or sputtering, plating, chemical vapor deposition (CVD), physical vapor deposition (PVD), atomic layer deposition (ALD), or other suitable methods.

With reference again to FIG. 1A, the disclosed DBTRS system 1001A includes a first DBTRS system to measure and detect the conductive quality of metal via 240A to the underlying interconnect structure including metal mesh 220, and a second DBTRS system to measure and detect the conductive quality of metal via 240B to the underlying interconnect structure including metal mesh 220. Specifically, the DBTRS systems are measuring the resistance of electrical/thermal conduction paths that include metal via 240A to metal mesh 220, and metal via 240B to metal mesh 220.

The first DBTRS system includes a pump laser 300A which emits a pump laser beam 301A incident at an angle θpumpincident on a conductive target area/reflective top surface 241A of metal via 240A, and a probe laser 400A which emits a probe laser beam 401A1 incident at an angle θprobeincident on the conductive target area/reflective top surface 241A of metal via 240A, which is reflected at an angle θprobereflected by the conductive target area/reflective top surface 241A of metal via 240A to provide a reflected probe laser beam 401A2 that is received by a reflectance detector 500A.

The second DBTRS system includes a pump laser 300B which emits a pump laser beam 301B incident at an angle θpumpincident on a conductive target area/reflective top surface 241B of metal via 240B, and a probe laser 400B which emits a probe laser beam 401B1 incident at an angle θprobeincident on the conductive target area/reflective top surface 241B of metal via 240B, which is reflected at an angle θprobereflected by the conductive target area/reflective top surface 241B of metal via 240B to provide a reflected probe laser beam 401B2 that is received by a reflectance detector 500B.

According to this example embodiment, the DUT includes a Si substrate 210 with the metal and dielectric composite structure 200 formed on the front surface of the wafer.

The reflectance detectors, e.g. photodetectors, 500A and 550B are operatively connected to a readout/detector circuit 600 which, in combination with the reflectance detectors 500A and 500B detect the reflected laser beams 401A2 and 401B2 , respectively, initially measuring the intensity/power of the reflected laser beams 401A2 and 401B2 and converting to intensity or power, voltage or current signals representative of the reflected laser beams 401A2 and 401B2. According to an example embodiment, the detector material: Si, Ge, GaAs, InGaAs, or InSb; the reflected probe laser angle θprobreflected=180−θ; and the probe incident angle θprobincident=θ. An output signal of the reflectance detectors 500A and 500B and/or readout/detector circuit 600 is “high” to indicate a metal via exposed surface 241A and 241B low temperature (conductivity state of metal via is normal or nonresistant), and a “low” to indicate a metal via exposed surface 241A and 241B high temperature((conductivity state of metal via is abnormal or resistant indicating a partial short or open condition). Alternatively, the output signals of the reflectance detectors 500A and 500B and/or readout/detector circuit 600 is reversed where “high” indicates a metal via exposed surface 241A and 241B high temperature (conductivity state of metal via is abnormal or resistant), and a “low” indicates a metal via exposed surface 241A and 241B low temperature((conductivity state of metal via is normal or nonresistant.

A wafer stage 100 including a wafer stage base 101, and a wafer holder 102 are configured to provide angular rotation and x-y-z directional motion of the wafer stage wafer holder 102 and the DUT 200/wafer fixed thereon.

While the DBTRS system shown in FIG. 1A and described includes the use of electric vias 240A and 240B represented as formed of similar materials, the disclosed method and system also can include measurement of the conductive interconnect states of metal vias and metal interconnect structures with different materials. Furthermore, the DBTRS system shown and described can be used to conductivity test conductive test areas, i.e. metal vias and metal interconnect structures such as contacts, electrical pads, etc., electrically connected to an underlying semiconductor structure such as a transistor device including drain, source and gate vias extending to the target test area.

While the embodiments described herein use two independent lasers, a pump laser 300A/300B and a probe laser 400A/400B, it is also within the scope of this disclosure to use a single physical laser that has a time delayed output of the incident pump laser beam and incident probe laser beams.

In operation, the DBTRS system includes the use of a reference thermal conduction value associated with a normal, i.e., short, or state that is representative of a desirable conduction path from the metal vias 240A and 240B to the metal mesh structure 220. The reference thermal conduction values are obtained from test samples of similar semiconductor DUT conductive test areas, where a plurality of reference thermal conduction values are obtained corresponding to a 1) a normal metal via or metal interconnection conduction path to an underlying interconnect structure, i.e. nonresistant path, 2) a partially open or short metal via or metal interconnection conduction path to an underlying interconnect structure, i.e. resistant path, and 3) an open metal via or metal interconnection conduction path to an underlying interconnect structure, i.e. highly resistant path.

The pump laser used for heating the conductive target area is a relatively short wavelength (e.g., about 700 nm or less), where the probe laser used for reflection contrast of the conductive target test area has a relatively long wavelength (e.g., about 5000 nm or less).

The reflectance detectors 500A and 500B collect the reflected laser signals 401A2 and 401B2 , respectively, of the probe laser (reflected laser angle θprobereflected=π−θprobeincident) which will have a higher reflectance from the exposed surfaces 241A and 241B of the metal vias at a relatively low temperature, and a relatively low reflectance at a higher temperature. The incident pump lasers 301A and 301B are absorbed by the metal vias 240A and 240B, respectively, and causes the metal vias 240A and 24B to have a temperature/reflectance change due to local heating. The metal vias 240A and 240B, which are normally connected to metal mesh 220, will have a relatively less heating effect due to the thermal conductive paths 711A and 711B of the metal mesh 220 to the metal vias 240A and 240B, while relatively more heating effect of the metal vias 240A and 240B will be detected in an isolated or partially isolated metal via (240A and/or 240B) due to the discontinuity of the thermal conductive paths 711A and 711B from the metal mesh 220 to one or both of the metal vias 240A and 240B.

With reference to FIG. 1B, shown is a time vs intensity graph of the input pump laser beam 301A;301B and input probe laser beam 401A;401B (Embodiment 1A) according to an example embodiment of the present disclosure; and FIG. 1C shows a graph of time vs intensity of the output or reflected probe laser beam 401A2;401B2 (Embodiment 1A) according to an example embodiment of the present disclosure.

As can be seen in FIGS. 1B and 1C, during operation of the disclosed DBTRS, the probe laser incident on the metal vias 240A and 240B, at an intensity of Ipumpincident, is delayed by deltatpp subsequent to the pump laser emission incident on the metal vias 204A and 240B, at an intensity of Iprobeincident. For the example shown in FIGS. 1B and 1C, a high intensity IH or a low intensity IL reflected probe laser signal Iproberefelctive is detected, where 1) IH corresponds to a relatively high reflected probe laser signal 410A2;401B2 indicating a relatively low temperature associated with the metal via exposed surfaces 241A;241B, which indicates a normal conductive path from the metal vias 240A;240B to the underlying interconnect structure including metal mesh 220, and 2) IL corresponds to a relatively low reflected probe laser signal 410A2;401B2 indicating a relatively high temperature associated with the metal via exposed surfaces 241A;241B, which indicates a resistant or open conductive path from the metal vias 240A;240B to the underlying interconnect structure including metal mesh 220.

With reference to FIG. 1D, shown is a further detailed view of a DBTRS system for conductivity inspection of a target test area (Embodiment 1A) according to an example embodiment of the present disclosure, the detailed view depicting the pump laser incident angle θpumpincident relative to the conductive test area, i.e. metal via, and depicting the probe laser incident angle θprobeincident and reflected probe laser angle θprobereflected relative to the conductive test area 701A;701B, i.e. exposed surfaces of metal vias 241A;241B.

With reference to FIG. 1E, shown is another further detailed view of a DBTRS system for conductivity inspection of a target test area (Embodiment 1A) according to an example embodiment of the present disclosure, the detailed view depicting the spacing or separation deltadpp of the pump laser beam 301A;301B incident on the conductive test area 241A;241B and the probe laser 401A1;401A2 incident on the conductive test area 241A;241B.

As shown, the metal via reflective top surface 241A;241B is only partially covered by an incident pump laser spot 301A;301B and an offset probe laser spot 401A1;401B1. Potential shapes of the metal via exposed surface 241A can include, but are not limited to, rectangular, circular, triangular, polygonal, etc.

According to an example embodiment, the pump and probe laser spots'301A;301B and 401A1;401B1, respectively, are offset, where: deltadpp (beam spot offset or spacing)=S*deltatpp (time delay of probing laser relative to pump laser), where S is the wafer moving speed. According to an example embodiment, deltadpp is from about 10 nm to about 1 mm and deltatpp is from about fs to about 1 s.

With reference to FIG. 1F, illustrated is a configuration of a DBTRS system 1001B for conductivity inspection of a target test area (Embodiment 1B) according to an example embodiment of the present disclosure, where the pump laser beam 301A and probe laser beam 401A1 are parallel and perpendicular to the DUT 200 (Device Under Test) conductive test area (Type I). Using this configuration, a confocal mirror arrangement (not shown), as used in a confocal microscope, separates the incident pump laser emission 301A and the reflected probe emission 401A2 (not shown in FIG. 1F). A dichroic mirror (not shown) reflects light with a shorter wavelength (pump laser 301A) while transmitting light with a longer wavelength (probe laser 401A1). This allows the light from the main source, i.e., the pump laser 301A, to pass through the objective to the sample (DUT 200), while the longer-wavelength light, i.e., the probe laser 401A1 or reflected probe laser 401A2 (not shown in FIG. 1F), to pass through the dichroic mirror.

With reference to FIG. 1G, illustrated is another configuration of a DBTRS system 1000C for conductivity inspection of a target test area (Embodiment 1C) according to an example embodiment of the present disclosure, where the pump laser beam 301A is obliquely aligned to the DUT 200 conductive test area, and the probe laser beam 401A1 is perpendicular to the DUT 200 conductive test area (Type II).

With reference to FIG. 1H, illustrated is another configuration of a DBTRS system 1000D for conductivity inspection of a target test area (Embodiment 1D) according to an example embodiment of the present disclosure, where the pump laser beam 301A is perpendicular to the DUT 200 conductive test area, and the probe laser beam 401A1 is obliquely aligned to the DUT 200 conductive test area (Type III).

With reference to FIG. 1I, illustrated is another configuration of a DBTRS system 1000E for conductivity inspection of a target test area (Embodiment 1E) according to an example embodiment of the present disclosure, where the pump laser beam 301A and probe laser beam 401A1 are obliquely aligned to the DUT 200 conductive test area (Type IV).

According to one example embodiment, the DBTRS systems specifications are as follows:
Pump laser 301A;301B wavelength of 100-700 nm, a pulse width of about 1 fs to about 1 s, a power of about 1 uW to about 1 W, and an incident angle θpumpincident of about 0-180 degrees;
Probe laser 401A1;401B1 wavelength of about 100-5000 nm, pulse width of about 1 fs to continuous wave (CW), power of about 1 nW˜mW, and Incident angle θprobeincident of about 0-180 degrees;
Time delay of probe laser deltatpp of about 1 fs to about 1 s; and
Probe laser spot distance deltadpp of about 10 nm to about 1 mm.

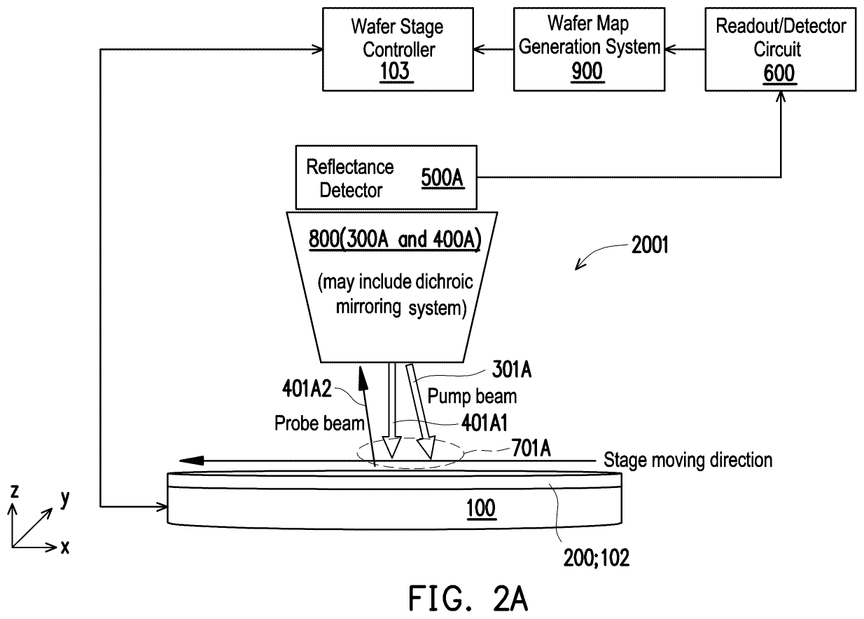

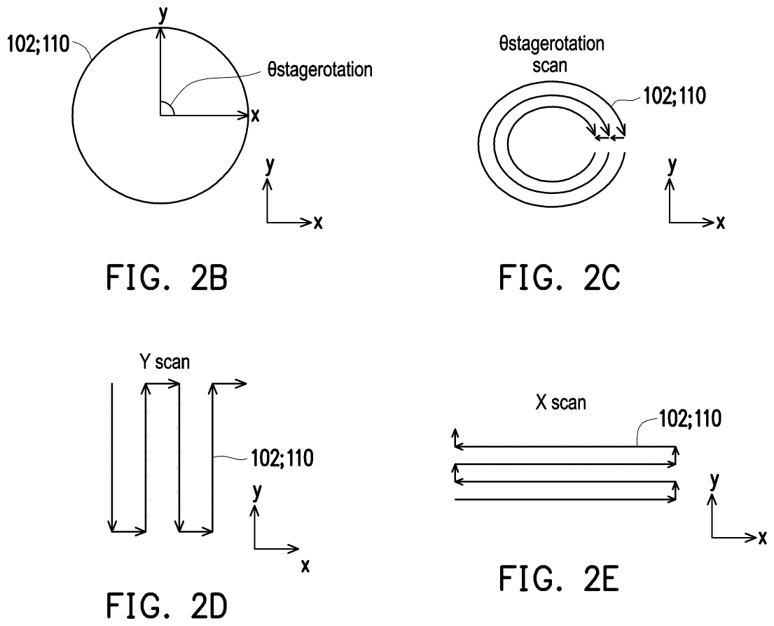

With reference to FIG. 2A, illustrated is another DBTRS system 2001 for conductivity inspection of a target test area (Embodiment 2) according to an example embodiment of the present disclosure, the DBTRS system 2001 including a wafer scanning configuration to perform a continuous scan of a wafer to generate a wafer map visually indicating the conductive path states of a plurality of conductive target test areas and associated interconnect structures on the wafer.

As shown, the DBTRS configuration includes a wafer stage controller 103, wafer map generation system 900 and a readout/detector circuit 600. A pump and probe laser head 800 performs the local scanning of a semiconductor structure to determine the conductive state of a conductive test area, e.g., metal via, metal interconnect, or other electrical contact to an underlying interconnect structure, as previously described, except here the pump laser 301A and probe laser 401A1 are housed within a common laser head unit 800.

During operation, the wafer stage controller 103 controls the movement of the wafer stage 100 to position/scan a DUT 200; wafer 102 using the DBTRS laser head. A readout/detector circuit 600 is configured to receive and process signals from the reflectance detector 500A, and output to the map generation system 900 conductive state signals/data representative of the conductive states of scanned DUT 200 metal vias, metal interconnects, and other electrical contact areas to generate a wafer map indicating the respective states of these scanned conductive areas. The generated wafer map can be used for determining the pass or fail of a fabricated wafer, or for tool diagnostic purposes, etc.

With reference to FIG. 2B, illustrated is the wafer 110 and wafer holder 102 rotational direction θstagerotation associated with the DBTRS system shown in FIG. 2A (Embodiment 2) according to an example embodiment of the present disclosure.

With reference to FIG. 2C, illustrated is a wafer 110 and wafer holder 102 rotational θstagerotation scan path associated with the DBTRS system shown in FIG. 2A (Embodiment 2) according to an example embodiment of the present disclosure.

With reference to FIG. 2D, illustrated is a wafer 110 and wafer holder 102 y directional scan path associated with the DBTRS system shown in FIG. 2A (Embodiment 2) according to an example embodiment of the present disclosure.

With reference to FIG. 2E, illustrated is a wafer 110 and wafer holder 102 x directional scan path associated with the DBTRS system shown in FIG. 2A (Embodiment 2) according to an example embodiment of the present disclosure.

According to an example embodiment,
Wafer 102 size: 6″/8″/12″ and coupon wafers less than 12″;
Moving capability of stage 100 and DUT 200: x, y, z and θstagerotation in x-y plane;
Moving direction of stage 100 and DUT 200: along pump 301A and probe beams 401A1;
Moving speed of stage 100 and DUT: S=0-10 m/s; and
Scanning method of wafer stage controller 103/wafer stage 100/DBTRS 2001: x scan/y scan/θstagerotation scan.

Other variations of a wafer scanning method could include measuring the reflectance of a plurality of conductive target test area on a wafer and simply averaging the measurements to determine outliers based on a predetermined statistical model for determining acceptance or rejection of a wafer/die.

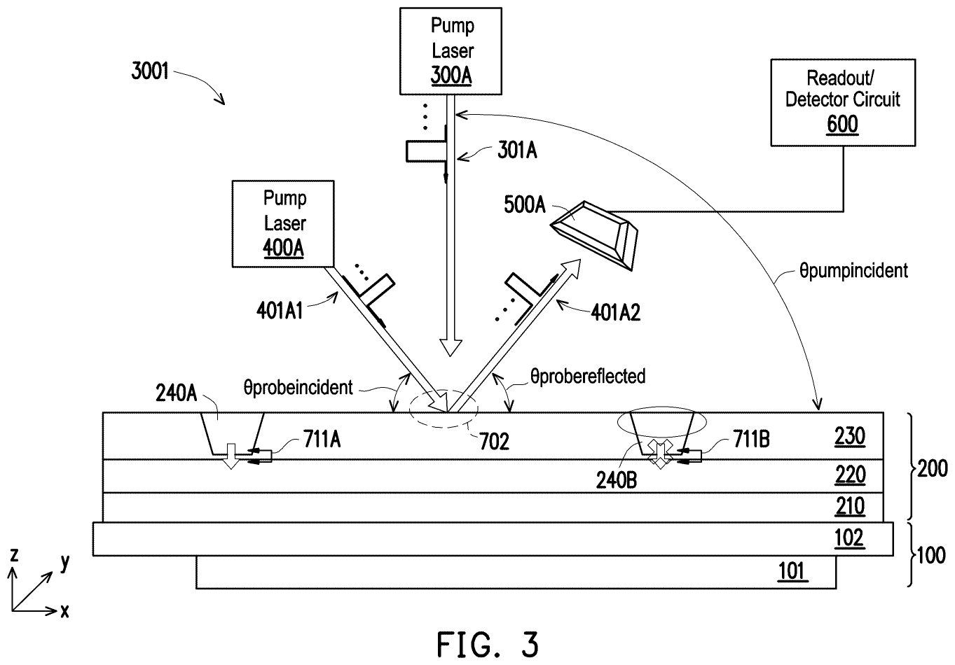

With reference to FIG. 3, illustrated is another DBTRS system 3001 for conductivity inspection of a target test area according to an example embodiment (Embodiment 3) of the present disclosure, the DBTRS system 3001 including a pump laser beam 301A and probe laser beam 401A1 incident on a dielectric area 702 of a dielectric layer(s) 230, the dielectric area 702 adjacent to metal vias 240A and 240B formed thru the dielectric layer(s) 230. Here the dielectric substrate material 230 temperature measurement, based on reflectivity of the probe laser 401A incident on the dielectric material region 702 is used to determine the conductive state of metal vias 240A and 240B. Alternatively, or in addition, the measurement of the dielectric material region 702, based on reflectivity of if the incident probe laser 400A can provide an indication of possible delamination of the dielectric material 230, where a low reflectivity (high temperature) indicates lack of thermal and electrical conduction of the dielectric region 230 to the metal mesh layer 220.

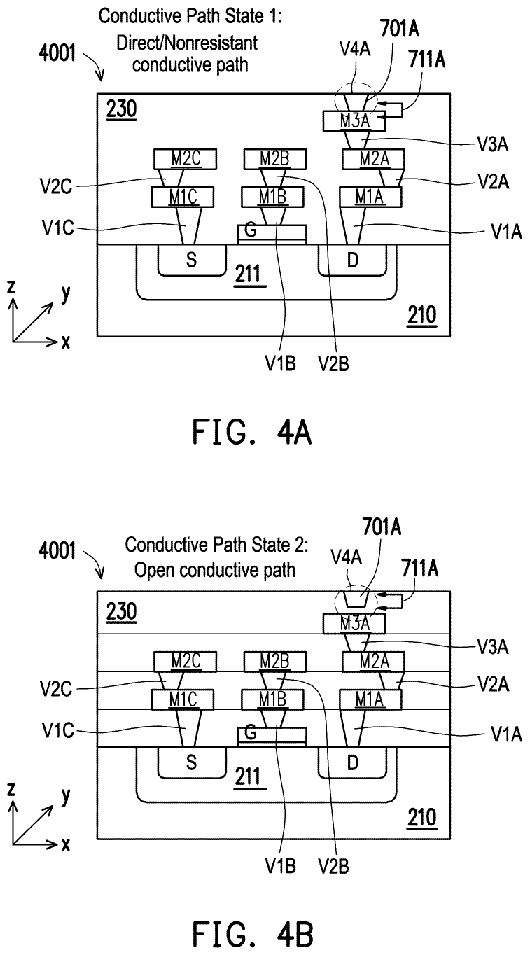

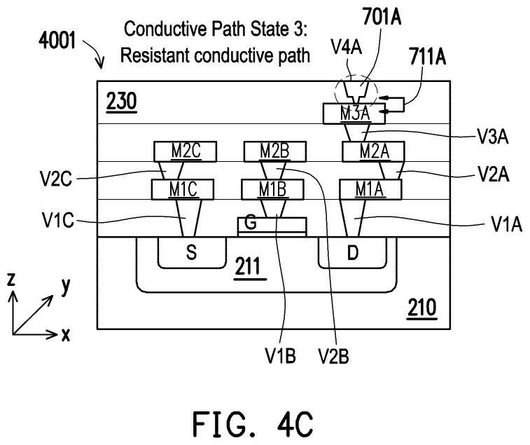

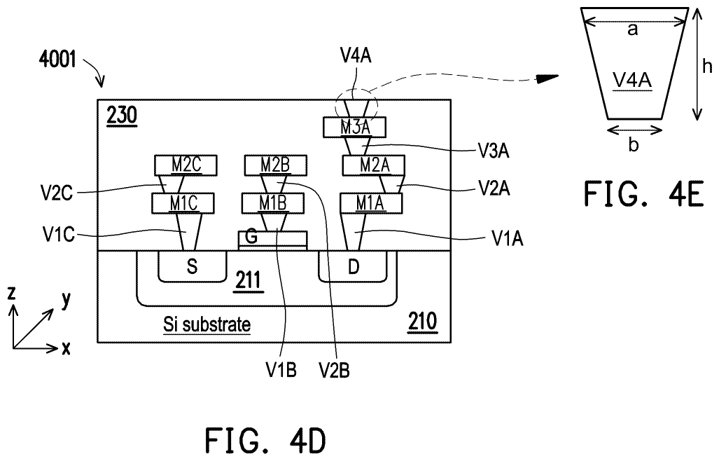

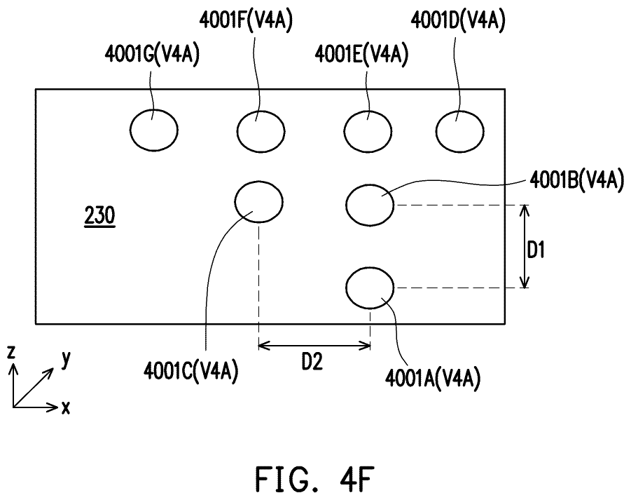

With reference to FIGS. 4A-4C, illustrated is a plurality of conductive path states determined by the disclosed DBTRS system, e.g. 1001A and 2001, the plurality of conductive path states including State 1: Direct/Nonresistant conductive path (FIG. 4A), State 2: Open conductive path (FIG. 4B) and State 3: Resistant conductive path (FIG. 4C), according to an example embodiment of the present disclosure.

As shown the DBTRS system is being used to test the conductive state of DUT 4001 metal via V4A to an underlying interconnect structure associated with a MOS transistor 211 (e.g., PMOS, NMOS) formed in a Si substrate 210 The metal via V4A is electrically connected to the drain region of transistor device 211 through a series of vias and metallization interconnects including M3A, V3A, M2A, V2A, M1A and V1A. According to this example, the dielectric material 230 surrounding the metal vias V1A, V2A, V3A and metal interconnects M1A, M2A and M3A is SiOx, SiNx, or SiON.

While not relevant for purposes of describing the operation of the DBTRS system for testing the DUT shown in FIGS. 4A-4C, the semiconductor device also includes other metal vias V1B, V2B, V1C and V2C and metal interconnects M1B, M2B, M1C and M2, which can be tested for their conductivity state as it relates to their electrical connectivity to their underlying interconnect structure using the DBTRS disclosed and applied at various stages of the fabrication of the DUT 4001.

In operation, the DBTRS pump and probe laser beams are incident to reflective surface 701A, where a normal, “Conductive Path State 1: Direct/Nonresistant conductive path”, as shown in FIG. 4A, is detected because the thermal conductivity of the exposed conductive test area, i.e., metal via 701A, to the underlying metal interconnect M3A is normal, or nonresistant.

A first abnormal conductive state of the metal via V4A is shown in FIG. 4B, “Conductive Path State 2: Open conductive path” where the thermal conductivity path from the metal via V4A and M3A is segmented and open, thereby providing a nonconductive path thermally. As a result, the temperature of the metal via is above normal, or a predetermined temperature threshold or reflectivity, and the reflected probe laser power is below what would be expected for a normal nonresistant conductive path from the metal via V4A to metal interconnect M3A.

A second abnormal conductive state of the metal via V4A is shown in FIG. 4C, “Conductive Path State 3: Resistant conductive path” where the thermal conductivity path from the metal via V4A and M3A is segmented and partially open, thereby providing a restricted or limited nonconductive path thermally. As a result, the temperature of the metal via is above normal, or a predetermined temperature threshold or reflectivity, and the reflected probe laser power is below what would be expected for a normal nonresistant conductive path from the metal via V4A to metal interconnect M3A.

With reference to FIG. 4D, illustrated is a another cross sectional view of an example semiconductor structure (Embodiment 4) as shown in FIGS. 4A-4C including a metal via V4A and underlying interconnect structure M3A that is tested for continuity using a DBTRS according to an example embodiment of the present disclosure, and with reference to FIG. 4E, illustrated is a detailed cross sectional view of the metal via shown in FIG. 4D (Embodiment 4) according to an example embodiment of the present disclosure.

According to this example embodiment:
a (metal via top width) is 10 nm˜500 nm;
b (metal via bottom width is 10 nm˜500 nm;
h (metal via height/thickness) is 10 nm˜1000 nm; and
a>b.

With reference to FIG. 4F, illustrated is a top of an example semiconductor structure (Embodiment 4) including a plurality of metal vias and underlying interconnect structures, as shown in FIG. 4D, that is tested for continuity using a DBTRS according to an example embodiment of the present disclosure. Each of the metal vias 4001A(V4A), 4001B(V4), 4001C(V4A), 4001D(V4), 4001E(V4A), 4001F(V4), and 4001G(V4) are electrically connected to respective underlying interconnect structures as previously described with reference to FIG. 4D, and are shown here to illustrate a partial wafer or die arrangement of DUTs for inspection using the DBTRS disclosed herein. According to an example embodiment, the spacing D1 and D2 of the metal vias 4001A(V4A), 4001B(V4), 4001C(V4A), 4001D(V4), 4001E(V4A), 4001F(V4), and 4001G(V4) is 10-1000 nm, however the vias and associated underlying interconnect structures can be spaced at any dimension D1 and D2 greater than 1000 nm.

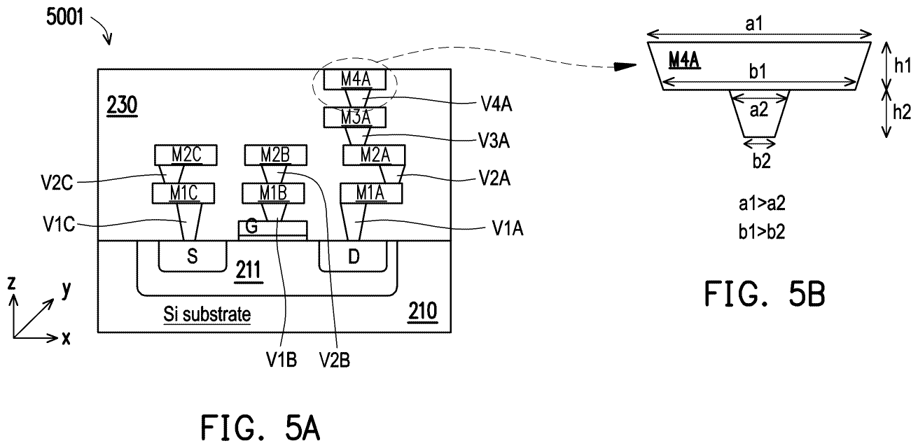

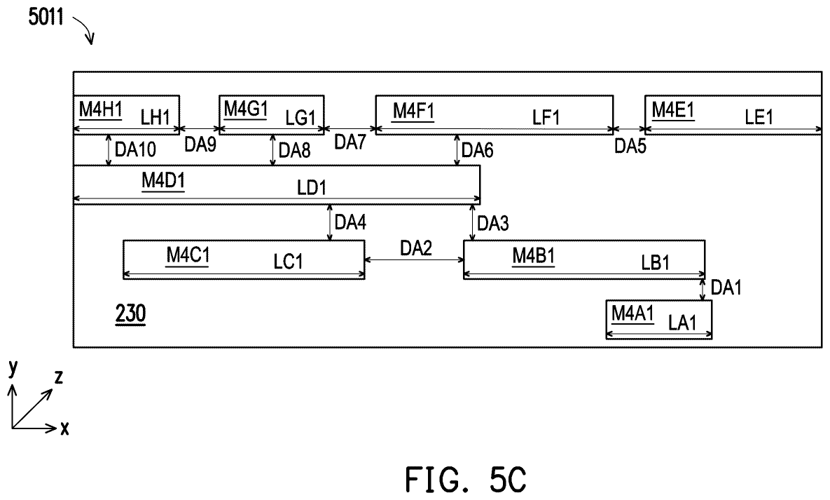

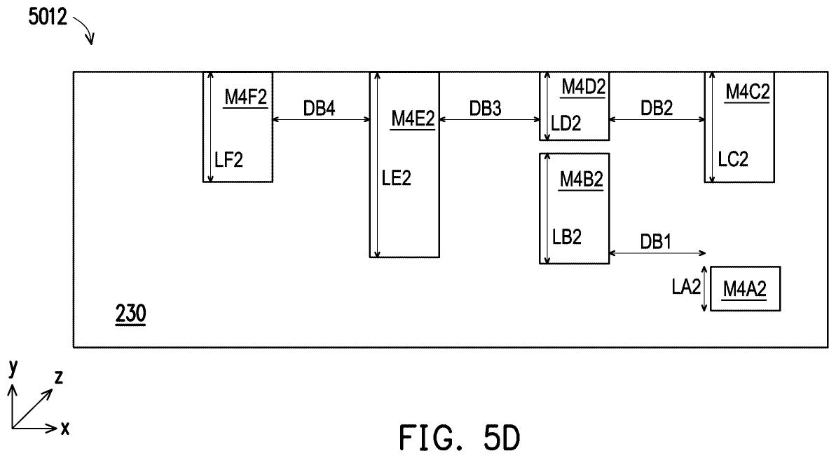

With reference to FIG. 5A, illustrated is a cross sectional view of an example semiconductor structure 5001 (Embodiment 5A) including a metal interconnect M4A and metal via V4A, and underlying interconnect structure, that is tested for continuity using a DBTRS according to an example embodiment of the present disclosure; FIG. 5B illustrates is a detailed cross sectional view of the metal interconnect M4A and via V4A shown in FIG. 5A (Embodiment 5A) according to an example embodiment of the present disclosure; FIG. 5C illustrates a top view of an example semiconductor partial wafer or die layout 5011 (Embodiment 5B) that includes a plurality of semiconductor structures similar to that shown in FIGS. 5A and 5B, the layout 5011 including a plurality of metal interconnects M4A1, M4B1, M4C1, M4D1, M4E1, M4F1, M4G1 and M4H1 and vias (not shown), and underlying interconnect structures (not shown), as shown in FIG. 5A, that is tested for continuity using a DBTRS according to an example embodiment of the present disclosure; and FIG. 5D illustrates is a top of another example semiconductor partial wafer or die layout 5012 (Embodiment 5C) that includes a plurality of semiconductor structures similar to that shown in FIGS. 5A and 5B, the layout 5012 including a plurality of metal interconnects M4A2, M4B2, M4C2, M4D2, M4E2 and M4F2 and vias (not shown), and underlying interconnect structures (not shown), as shown in FIG. 5A, that is tested for continuity using a DBTRS according to an example embodiment of the present disclosure.

According to this example embodiment:
a1 (metal interconnect top width)>b1 (metal interconnect bottom width;
a2 (metal via top width)>b2 (metal via bottom width);
a1>a2, b1>b2;
a1 & b1 are from about 10 nm˜50 um;
a2 & b2 are from about 10 nm˜500 nm;
h1 (metal interconnect height) & h2 (metal interconnect height) are from about 10 nm˜1000 nm;
LA1, LB1, LC1, LD1, LE1, LF1, LG1, LH1, LA2, LB2, LC2, LD2, LE2 and LF2 are from about 10 nm˜50 um; and
DA1, DA2, DA3, DA4, DA5, DA6, DA7, DA8, DA9, DA10, DB1, DB2, DB3 and DB4 are from about 10 nm˜500 nm.

Advantages and benefits associated with the dimensional ranges listed above include, but are not limited to, the disclosed method and system for measuring a conductive state of metal contacts and/or vias formed in semiconductor substrate structures of a variety of design functional configurations and/or interconnect structures.

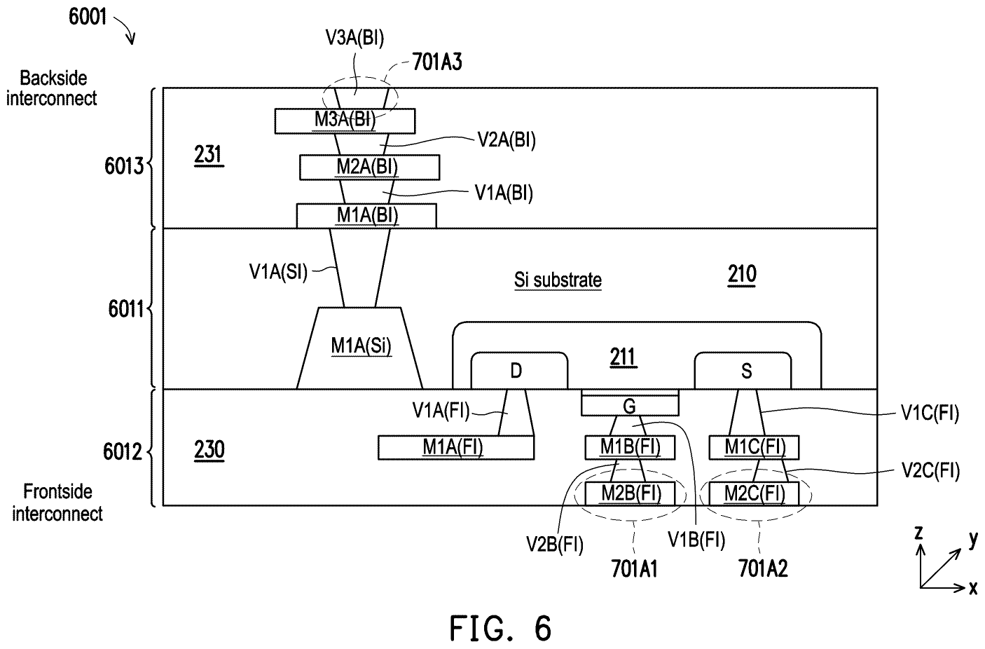

With reference to FIG. 6, illustrated is a cross sectional view of an example double sided metal interconnect semiconductor structure DUT 6001 (Embodiment 6) including: a frontside metal interconnect structure 6012; a Si substrate 210 including a MOS transistor device 211 and a metal interconnect structure including metal interconnect M1A(Si) and metal via V1A(Si) surrounded or encased within the Si substrate 210; and a backside metal interconnect structure 6013, where the frontside 6012 and backside 6013 metal interconnect structures are tested for electrical continuity using a DBTRS as previously described.

According to this DUT embodiment, the DUT 6001 includes a Si substrate (e.g., P-Silicon, N-silicon) 6011 including a MOS transistor 211 e.g. (PMOS, NMOS) formed in the Si substrate 210, which is structurally and electrically integrated with a frontside interconnect structure 6012 and a backside interconnect structure 6013.

The frontside interconnect structure 6012 provides electrical connectivity of the transistor 211 drain using: a conductive path including metal interconnect M1A(F1) and metal via V1A(F1); electrical connectivity of the transistor 211 gate using a conductive path including metal interconnect M2B(F1), metal via V2B(F1), metal interconnect M1B(F1) and metal via V1B(F1); and electrical connectivity of the transistor 211 source using a conductive path including metal interconnect M2C(F1), metal via V2C(F1), metal interconnect M1C(F1) and metal via V1C(F1). A dielectric material 230 (e.g., SiOx, SiNx, SiON) surrounds or encases the metal vias and metal interconnects within dielectric material 230.

The backside interconnect structure 6013 provides electrical connectivity of a Si Substrate 210 through silicon metal interconnect structure using a conductive path including metal interconnect M1A(Si), metal via V1A(Si), metal interconnect M1A(B1), metal via V1A(B1), metal interconnect M2A(B1), metal via V2A(B1), metal interconnect M3A(B1), and metal via V3A(B1), (e.g. Cu, W, Al). A dielectric material 231 (e.g., SiOx, SiNx, SiON) surrounds or encases the metal vias and metal interconnects within dielectric material 231.

During operation, the DBSTR system inspects the conductive integrity of the frontside interconnect 6012 metal interconnects M2B(F1) and M2C(F1) which include laser incident and reflective surface areas 701A1 and 701A2, respectively. Specifically, the DBTRS system performs an operation as previously described with reference to FIG. 1A, except the exposed reflective surfaces 701A1 and 701A2 of metal interconnects are scanned with the DBSTR Pump and Probe lasers to determine the conductivity states of their respective metal interconnects M2B(F1) and M2C(FI), i.e. their conductive integrity of the conductive path from metal interconnects M2B(F1) and M2C(FI) to the underlying interconnect structures, et. al. metal via V2B(F1) and metal via V2C(F1), respectively.

During operation, the DBSTR system inspects the conductive integrity of the backside interconnect 6013 metal via V3A(B1) which includes laser incident and reflective surface area 701A3. Specifically, the DBTRS system performs an operation as previously described with reference to FIG. 1A, where the exposed reflective surfaces 701A3 is scanned with the DBSTR Pump and Probe lasers to determine the conductivity state of metal via V3A(B1), i.e., the conductive integrity of the conductive path of metal via V3A(BI) to the underlying interconnect structures, et. al. metal interconnect M3A(B1).

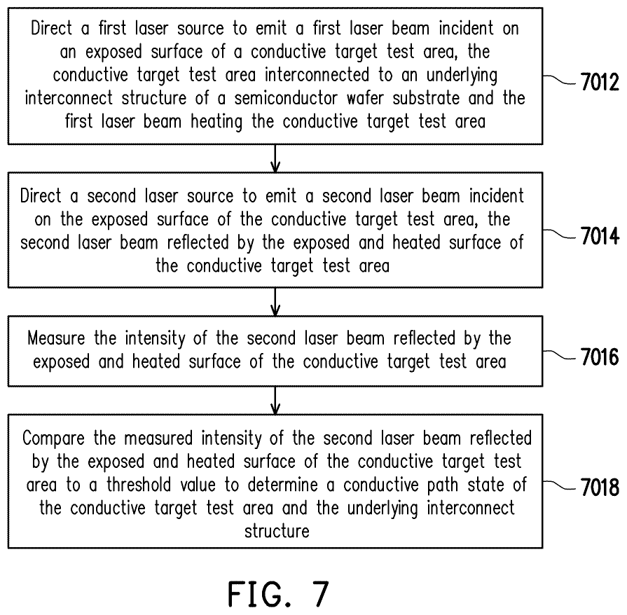

With reference to FIG. 7, illustrated is a flow chart of a method of detecting a conductive path state of a conductive target test area interconnect structure on a semiconductor wafer substrate according to an example embodiment of the present disclosure. While the method steps are discussed below in terms of the inspection of a single DUT, such discussion should also be broadly construed as applying to the inspection of a plurality of DUTs as well as executing in a iterative manner to perform a continuous scan and mapping of a wafer under test for determining the electrically conductive integrity of the wafer's exposed conductive features and their underlying electrical connectivity to the underlying interconnect structure.

At step 7012, the method directs a first laser source to emit a first laser beam incident on an exposed surface of a conductive target test area, the conductive target test area interconnected to an underlying interconnect structure of a semiconductor wafer substrate and the first laser beam heating the conductive target test area.

At step 7014, the method directs a second laser source to emit a second laser beam incident on the exposed surface of the conductive target test area, the second laser beam reflected by the exposed and heated surface of the conductive target test area.

At step 7016, the method measures the intensity of the second laser beam reflected by the exposed and heated surface of the conductive target test area.

At step 7018, the method compares the measured intensity of the second laser beam reflected by the exposed and heated surface of the conductive target test area to a threshold value to determine a conductive path state of the conductive target test area and the underlying interconnect structure.

Based on the above discussions, it can be seen that the present disclosure offers advantages. It is understood, however, that other embodiments may offer additional advantages, and not all advantages are necessarily disclosed herein, and that no particular advantage is required for all embodiments. One advantage is that the disclosed DBTRS methods and systems provide for measurement of the conductive integrity of metal vias and metal interconnects using one or more lasers and wafer mapping technology, as compared to a VC method and system which is local in application, which in turn can improve the throughput of a wafer quality inspection process.

In the following, some further embodiments are described.

In a nonlimiting illustrative embodiment, a method of detecting a conductive path state of a conductive target test area interconnect structure on a semiconductor wafer substrate is disclosed, the method comprising: directing a first laser source to emit a first laser beam incident on an exposed surface of a conductive target test area including a metal interconnect or a via, the conductive target test area interconnected to an underlying interconnect structure of a semiconductor wafer substrate and the first laser beam heating the conductive target test area; directing a second laser source to emit a second laser beam incident on the exposed surface of the conductive target test area, the second laser beam reflected by the exposed surface of the conductive target test area at an intensity that is dependent on a temperature of the conductive target test area, where a reflectivity of the conductive target test area exposed surface is inversely proportional to the temperature of the conductive target test area; measuring the intensity of the second laser beam reflected by the exposed surface of the conductive target test area, and comparing the measured intensity of the second laser beam reflected by the exposed surface of the conductive target test area to a threshold value to determine a conductive path state of the conductive target test area and the underlying interconnect structure, the conductive path state representing an electrical conductivity state from the conductive target test area to the underlying interconnect structure which is one of a) a direct nonresistant conductive path from the conductive target test area to the underlying interconnect structure, b) an open conductive path from the conductive target test area to the underlying interconnect structure, and c) a resistive conductive path from the conductive target test area to the underlying interconnect structure.

In another nonlimiting illustrative embodiment, a wafer conductive path state measurement system is disclosed, the system comprising: a wafer stage including a wafer stage base and a wafer holder; a first laser source emitting a first laser beam incident on an exposed surface of a conductive target test area on a wafer held by the wafer holder, the conductive target test area including a metal interconnect or a via, the conductive target test area interconnected to an underlying interconnect structure and the first laser beam heating the conductive target test area; a second laser source emitting a second laser beam incident on the exposed surface of the conductive target test area, the second laser beam reflected by the exposed surface of the conductive target test area at an intensity that is dependent on a temperature of the conductive target test area, where a reflectivity of the conductive target test area exposed surface is inversely proportional to the temperature of the conductive target test area; a detector measuring the intensity of the second laser beam reflected by the exposed surface of the conductive target test area, and comparing the measured intensity of the second laser beam reflected by the exposed surface of the conductive target test area to a threshold value to determine a conductive path state of the conductive target test area and the underlying interconnect structure, the conductive path state representing an electrical conductivity state from the conductive target test area to the underlying interconnect structure which is one of a) a direct nonresistant conductive path from the conductive target test area to the underlying interconnect structure, b) an open conductive path from the conductive target test area to the underlying interconnect structure, and c) a resistive conductive path from the conductive target test area to the underlying interconnect structure.

In another nonlimiting illustrative embodiment, a method of detecting a conductive path state of a conductive target test area to an interconnect structure on a semiconductor wafer substrate is disclosed, the method comprising: directing a first radiation source to emit a first radiation on an exposed surface of a conductive target test area or an exposed surface of a dielectric region adjacent to the conductive target test area, the conductive target test area interconnected to an underlying interconnect structure of a semiconductor wafer substrate and the first radiation heating the conductive target test area or the dielectric region; directing a second radiation source to emit a laser beam incident on the exposed surface of the conductive target test area or the exposed surface of a dielectric region, the laser beam reflected by the exposed surface of the conductive target test area or the exposed surface of the dielectric region at an intensity that is dependent on a temperature of the conductive target test area or the dielectric region, where a reflectivity of the exposed surface is inversely proportional to the temperature of the conductive target test area or the temperature of the dielectric region; measuring the intensity of the laser beam reflected by the exposed surface of the conductive target test area or the exposed surface of the dielectric region, and comparing the measured intensity of the laser beam reflected by the exposed surface of the conductive target test area or the exposed surface of the dielectric region to a threshold value to determine a conductive path state of the conductive target test area and the underlying interconnect structure, the conductive path state representing an electrical conductivity state from the conductive target test area to the underlying interconnect structure which includes one or more of a) a direct nonresistant conductive path from the conductive target test area to the underlying interconnect structure, b) an open conductive path from the conductive target test area to the underlying interconnect structure, and c) a resistive conductive path from the conductive target test area to the underlying interconnect structure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of detecting a conductive path state of a conductive target test area interconnect structure on a semiconductor wafer substrate, the method comprising:
directing a first laser source to emit a first laser beam incident on an exposed surface of a conductive target test area including a metal interconnect or a via, the conductive target test area interconnected to an underlying interconnect structure of a semiconductor wafer substrate and the first laser beam heating the conductive target test area;
directing a second laser source to emit a second laser beam incident on the exposed surface of the conductive target test area, the second laser beam reflected by the exposed surface of the conductive target test area at an intensity that is dependent on a temperature of the conductive target test area, where a reflectivity of the conductive target test area exposed surface is inversely proportional to the temperature of the conductive target test area;
measuring the intensity of the second laser beam reflected by the exposed surface of the conductive target test area, and
comparing the measured intensity of the second laser beam reflected by the exposed surface of the conductive target test area to a threshold value to determine a conductive path state of the conductive target test area and the underlying interconnect structure, the conductive path state representing an electrical conductivity state from the conductive target test area to the underlying interconnect structure which is one of a) a direct nonresistant conductive path from the conductive target test area to the underlying interconnect structure, b) an open conductive path from the conductive target test area to the underlying interconnect structure, and c) a resistive conductive path from the conductive target test area to the underlying interconnect structure.

2. The method of claim 2, wherein first laser beam has a wavelength of about 700 nm or less, and the second laser beam has a wavelength of about 100 nanometers to about 5000 nanometers.

3. The method of claim 2, wherein the first laser beam and the second laser beam have different wavelengths, and the first laser source is a pump laser and the second laser source is a probe laser.

4. The method of claim 3, wherein the pump laser has a pulse width of about 1 femtosecond to about 1 second, a power of about 1 microwatt to about 1 watt, the pump laser is located at an incident angle of 0° to 180° relative to the exposed surface of the conductive target test area, and the pump laser operates at a wavelength that is less than a wavelength of the probe laser.

5. The method of claim 3, wherein the probe laser has a pulse width of about 1 femtosecond to about a continuous wave (CW)1 second, a power of about 1 nanowatts to 1 microwatt, the probe laser is located at an incident angle of 0° to 180° relative to the exposed surface of the conductive target test area, and the probe laser operates at a wavelength that is greater than a wavelength of the pump laser.

6. The method of 1, wherein a photodetector circuit measures the intensity of the second laser beam reflected by the exposed surface of the conductive target test area, and the photodetector circuit outputs a voltage or current signal representative of the measured intensity of the second laser beam reflected by the exposed surface of the conductive target test area.

7. The method of claim 1, wherein the second laser beam is emitted incident on the exposed surface of the conductive target test area after a time delay subsequent to the first laser beam being emitted incident on the exposed surface of the conductive target test area, the time delay from about 1 femtosecond to about 1 second.

8. The method of claim 1, wherein the first laser beam is emitted incident on a first spot of the exposed surface of the conductive target test area, and the second laser beam is emitted incident on a second spot of the exposed surface of the conductive target test area, and a distance between the first laser spot and the second laser spot is from about 10 nanometers to about 1 millimeter.

9. The method of claim 1, wherein the first laser source is oriented perpendicular or obliquely relative to the exposed surface of the conductive target test, and the second laser source is oriented vertically or obliquely relative to the exposed surface of the conductive target test.

10. The method of claim 1, wherein the exposed surface of the conductive target test area has a diameter or length of about 10 nanometers to about 50 micrometers.

11. A wafer conductive path state measurement system, comprising:
a wafer stage including a wafer stage base and a wafer holder;
a first laser source emitting a first laser beam incident on an exposed surface of a conductive target test area on a wafer held by the wafer holder, the conductive target test area including a metal interconnect or a via, the conductive target test area interconnected to an underlying interconnect structure and the first laser beam heating the conductive target test area;
a second laser source emitting a second laser beam incident on the exposed surface of the conductive target test area, the second laser beam reflected by the exposed surface of the conductive target test area at an intensity that is dependent on a temperature of the conductive target test area, where a reflectivity of the conductive target test area exposed surface is inversely proportional to the temperature of the conductive target test area;
a detector measuring the intensity of the second laser beam reflected by the exposed surface of the conductive target test area, and comparing the measured intensity of the second laser beam reflected by the exposed surface of the conductive target test area to a threshold value to determine a conductive path state of the conductive target test area and the underlying interconnect structure, the conductive path state representing an electrical conductivity state from the conductive target test area to the underlying interconnect structure which is one of a) a direct nonresistant conductive path from the conductive target test area to the underlying interconnect structure, b) an open conductive path from the conductive target test area to the underlying interconnect structure, and c) a resistive conductive path from the conductive target test area to the underlying interconnect structure.

12. The system of claim 11, wherein the first laser beam and the second laser beam have different wavelengths, and the first laser source is a pump laser and the second laser source is a probe laser

13. The system of claim 12, wherein the pump laser has a pulse width of about 1 femtosecond to about 1 second, a power of about 1 microwatt to about 1 watt, the pump laser is located at an incident angle of 0° to 180° relative to the exposed surface of the conductive target test area, and the pump laser operates at a wavelength that is less than a wavelength of the probe laser.

14. The system of claim 12. wherein the probe laser has a pulse width of about 1 femtosecond to about a continuous wave (CW)1 second, a power of about 1 nanowatts to 1 microwatt, the probe laser is located at an incident angle of 0° to 180° relative to the exposed surface of the conductive test area, and the probe laser operates at a wavelength that is greater than a wavelength of the pump laser.

15. The system of claim 11, wherein the second laser beam is emitted incident on the exposed surface of the conductive target test area after a time delay subsequent to the first laser beam being emitted incident on the exposed surface of the conductive target test area, the time delay from about 1 femtosecond to about 1 second.

16. The system of claim 11, wherein the first laser beam is emitted incident on a first spot of the exposed surface of the conductive target test area, and the second laser beam is emitted incident on a second spot of the exposed surface of the conductive target test area, and a distance between the first laser spot and the second laser spot is from about 10 nanometers to about 1 millimeter.

17. The system of claim 11, further comprising:
a wafer stage controller operatively connected to the wafer stage, the wafer stage controller configured to move a wafer fixed to the wafer holder relative to the first and second laser beams to perform a continuous scan of the wafer and detect the conductive path state of a plurality of conductive target test area and associated interconnect structures on the wafer;
a wafer map generation system operatively connected to the wafer conductive path state measurement system, the wafer map generation system generating a wafer map visually indicating the conductive path states of the plurality of conductive target test areas and associated interconnect structures on the wafer.

18. A method of detecting a conductive path state of a conductive target test area to an interconnect structure on a semiconductor wafer substrate, the method comprising:
directing a first radiation source to emit a first radiation on an exposed surface of a conductive target test area or an exposed surface of a dielectric region adjacent to the conductive target test area, the conductive target test area interconnected to an underlying interconnect structure of a semiconductor wafer substrate and the first radiation heating the conductive target test area or the dielectric region;
directing a second radiation source to emit a laser beam incident on the exposed surface of the conductive target test area or the exposed surface of a dielectric region, the laser beam reflected by the exposed surface of the conductive target test area or the exposed surface of the dielectric region at an intensity that is dependent on a temperature of the conductive target test area or the dielectric region, where a reflectivity of the exposed surface is inversely proportional to the temperature of the conductive target test area or the temperature of the dielectric region;
measuring the intensity of the laser beam reflected by the exposed surface of the conductive target test area or the exposed surface of the dielectric region, and
comparing the measured intensity of the laser beam reflected by the exposed surface of the conductive target test area or the exposed surface of the dielectric region to a threshold value to determine a conductive path state of the conductive target test area and the underlying interconnect structure, the conductive path state representing an electrical conductivity state from the conductive target test area to the underlying interconnect structure which includes one or more of a) a direct nonresistant conductive path from the conductive target test area to the underlying interconnect structure, b) an open conductive path from the conductive target test area to the underlying interconnect structure, and c) a resistive conductive path from the conductive target test area to the underlying interconnect structure.

19. The method of claim 18, wherein the second laser beam is emitted incident on the exposed surface of the conductive target test area or the exposed surface of the dielectric region after a time delay subsequent to the first laser beam being emitted incident on the exposed surface of the conductive target test area or the exposed surface of the dielectric region, the time delay from about 1 femtosecond to about 1 second.

20. The method of claim 18, wherein the first laser beam is emitted incident on a first spot of the exposed surface of the conductive target test area or the exposed surface of the dielectric region, and the second laser beam is emitted incident on a second spot of the exposed surface of the conductive target test area or the exposed surface of the dielectric region, and a distance between the first laser spot and the second laser spot is from about 10 nanometers to about 1 millimeter.
